(19) United States
(12) Patent Application Publication
(10) Pub. No.: US 2003/0099530 A1
(43) Pub. Date: May 29, 2003

(54) Unloader for discharging dry materials from bulk bags

(76) Inventor: Timothy C. Bonerb, Jackson, NH (US)

Correspondence Address: DECKER LAW OFFICE, 1 NEW HAMPSHIRE AVE., SUITE 125, PORTSMOUTH, NH, 03801, US

(21) Appl. No.: 09/994,168

(22) Filed: Nov. 26, 2001

(51) Int. Cl. B65G 51/00

(52) U.S. Cl. 414/412

(57) ABSTRACT

An unloader for discharging and feeding dry, granular type materials from bulk bags. Among the many improvements of the discharge apparatus is an open frame and offset discharge location. Other improvements include an I-Beam and frame design that keeps the hoist movement within the four corner posts of the frame. The unloader may be provided with vibrators, vibration isolators, or load cells to assist in the discharge function.

### BACKGROUND

1. Field of Invention

This invention relates to unloaders for discharging dry and semi-dry materials from bulk bags.

2. Description of Related Art

As many processors improve their operations by using bulk bags, instead of handling and manually dumping 50 lbs. and 100 lbs. paper bags, the need for a safer, more compact and flexible frame design of bulk bag unloaders has grown.

One of the more vexing problems in handling bulk bags is the requirement of a tall, four-posted frame with a cantilevered I-Beam that extends outward at the top of the frame so that a bulk bag can be lifted from its pallet on the floor up and onto the discharge apparatus of the unloader frame. The typical unloader frame is generally equipped with several diagonal and horizontal bracing structures between the four vertical, corner posts and hoist apparatus. This extra bracing around the frame makes it difficult to interface other types of feeding, dust collection and discharge equipment close to the discharge spout location of the bulk bag. Other problems and hazards are created when lifting a heavy bulk bag with the extended I-Beam configuration.

### SUMMARY

It is the object of the invention to use a smaller footprint for a bulk bag unloader.

Another object of the invention is lift and discharge a bulk bag on a standard sized unloader frame without the use of a cantilevered I-Beam. Another object of the invention is to provide a safer method of lifting a bulk bag for unloading.

Yet another object of the invention is to provide a more open and accessible frame around the bulk bag when it placed on the unloader.

Another object of the invention is to use a pick-up location and discharge location within the area of a four-posted unloader frame.

Another object of the invention is to allow other types of conveying, dust collection and metering devices to be interfaced with the unloader frame closer to the discharge spout of the bulk bag.

Yet another object of the invention is to eliminate the use of secondary bracing structures on the unloading frame.

Another object of the invention is to provide greater flexibility to where the horizontal frames may be located on the four-vertical posts.

### DRAWINGS

FIG. 1 is a side view of a bulk bag unloader with one bag positioned for discharge while a second bag is staged on the floor waiting to be lifted into position and discharged.

FIG. 2 is a side view of a bulk bag unloader frame with the hoist in position to lift a full bulk bag from its pallet on the floor to the discharge position.

FIG. 3 is a front view of a bulk bag lowered over the base ram and tray support for discharging.

FIG. 4 is a top of a bulk bag unloader with an open side and offset discharge location.

FIG. 5 is a side view of a bulk bag unloader showing details of the bag support means.

### DESCRIPTION

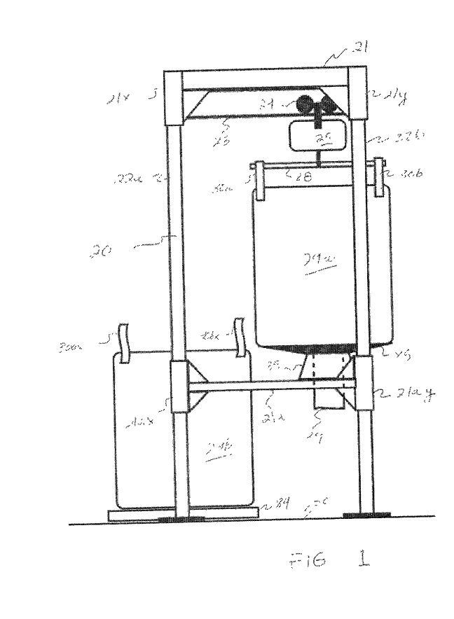

FIG. 1 is a side view of unloader frame 20. Top frame support 21 is equipped with corner brackets 21x and 21y (21v and 21z not shown) and bottom frame 21a is equipped with corner brackets 21ax and 21ay (21av and 21az not shown) to secure corner posts 22a and 22b (22c and 22d not shown) in position to form unloader frame 20. Unlike other bulk bag unloaders, I-beam 23 does not extend outside of the perimeter of corner posts 22a, 22b, 22c and 22d. I-beam 23 is secured to top frame 21 and allows hoist 25 to move between posts 22a and 22b via trolley 24. Bag 29a is held in position by bag support frame 28 and bag support tray 85. Bag support tray 85 may be located off center within the four corner posts 22a, 22b, 22c and 22d. Bag 29b is on pallet 84 in a location within the four corner posts 22a, 22b, 22c and 22d so that it can be lifted with hoist 25 when moved to the left end of I-beam 23. Corner brackets 21ay, 21ax, 21av and 21az of bottom frame 21a are designed to provide lateral support and can be located any where along the corner posts 22a, 22b, 22c and 22d to allow for the height of bag support tray 85 to be adjustable. Corner brackets 21x, 21v, 21y and 21z also add lateral support and rigidity to unloader frame 20 and may also be secured at any elevation.

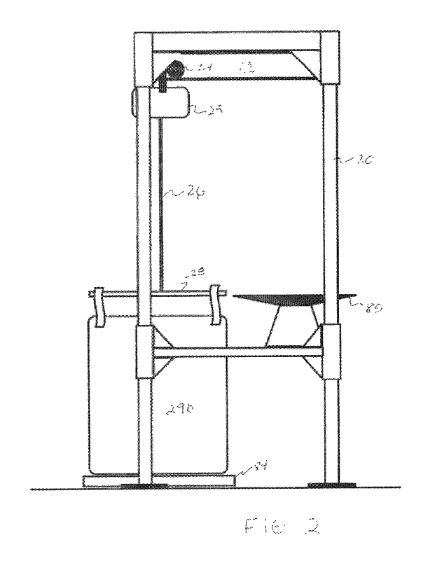

FIG. 2 is a side view of unloader frame 20 with hoist 25 moved along I-beam 23 via trolley 24 to a position over bag 29b. Chain 26 and bag frame 28 are lowered for bag to be lifted. Bag 29b is staged in the open frame area of unloader 20 on floor 50. Bag support tray 85 is empty, ready for bag 29b to be positioned thereon.

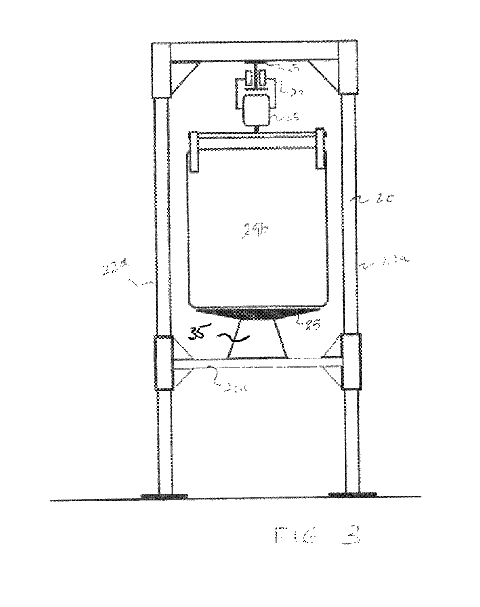

FIG. 3 is a front view of unloader frame 20 with bag 29b lowered onto ram base 35 and bag support frame 85. Bottom frame 21a does not have a support member located between vertical posts 22a and 22d to provide an open area directly under I-beam 23, trolley 24 and hoist 25.

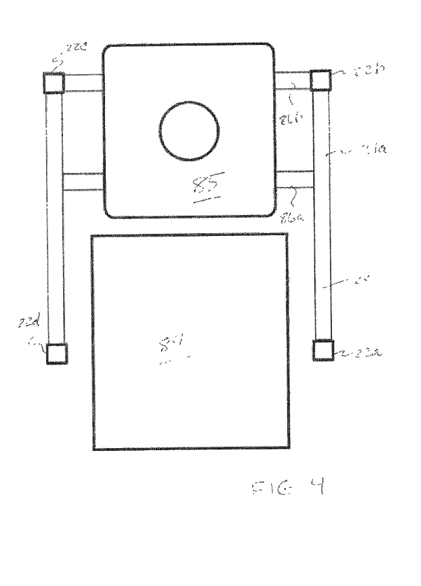

FIG. 4 is a top view of bottom frame 21a secured to vertical posts 22a, 22b, 22c and 22d. Bag support tray is supported by cross beam supports 86a and 86b. Pallet 84 is shown on floor in an open area of unloader frame 20. Because a cross support brace is not used between vertical posts 22a and 22d of bottom frame 21a and the bag support tray 85 is located off center of unloader frame 20, the I-Beam and Hoist Assembly (not shown) do not have to extend beyond vertical posts 22a, 22b, 22c and 22d.

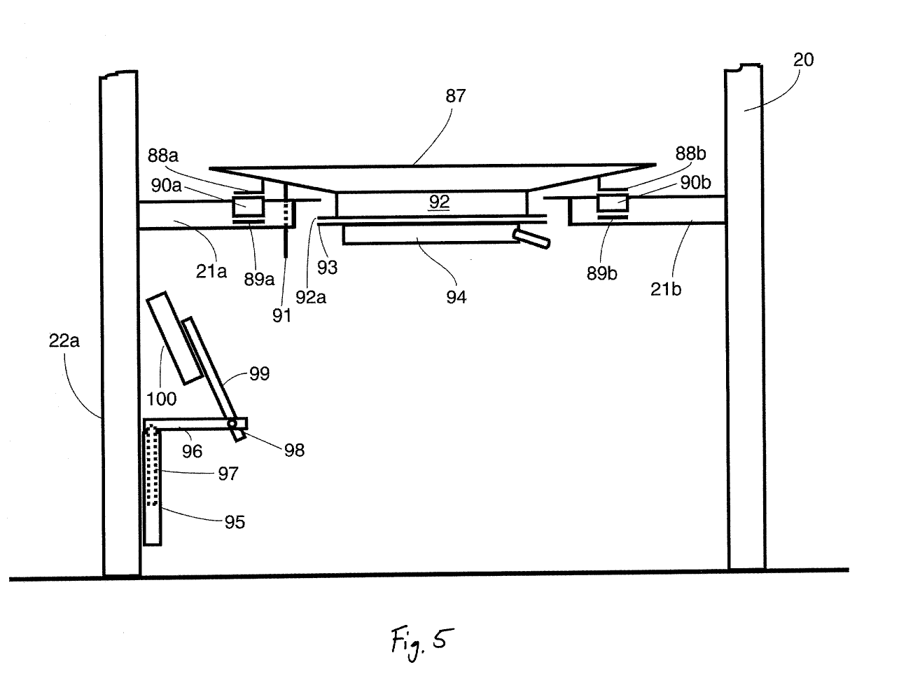

FIG. 5 is an end view of the lower section of the unloader with seat housing 95 secured to vertical support post 22a. Axle 97 of seat frame 96 is placed inside seat housing 95 to allow seat frame 96 to swivel off support post 22a. Seat extension support 99, with seat 100 attached, is mounted to seat frame 96 at pivot joint 98. Seat 100 may be mounted in a stationary position or in a swivel and foldable configuration as shown, to assist operator with the set up and discharge of a bulk bag on the unloader. It is understood that any configuration of the unloader may be provided with a seat 100, and not just the configuration shown in FIG. 5.

To provide the unloader with a variety of discharge options to handle different sized bags and/or materials with varying flow characteristics, bag support hopper 87 is equipped with hopper brackets 88a and 88b (88c and 88d not shown) that may be supported by unloader frame brackets 89a and 89b (89c and 89d not shown) on horizontal support frames 21a and 21b (21c and 21d not shown). Bag support hopper 87 may be provided as a rectangular or conical shape with various slope angles. Spacers 90a and 90b (90c and 90d not shown) are positioned between hopper brackets 88a and 88b (88c and 88d not shown) and unloader frame brackets 89a and 89b (89c and 89d not shown). Spacers 90a and 90b (90c and 90d not shown) may be interchanged with vibration isolators, load cells or other discharge devices as the configuration dictates. It is intended that the vibration isolators, load cells, and other discharge devices fit in the same space as the spacers as shown in FIG. 5 to facilitate manufacture and/or reconfiguration of the unloader. Spacers 90 may be supplied in one or more units as required to support bag support hopper 87. If vibration is desired to assist in breaking up settled material inside the bulk bag, a vibrator may be secured to vibration flange 91 and vibration isolators used instead of spacers 90. Hopper flange ring 92 on bag support hopper 87 is equipped with accessory mounting flange 92a. Discharge device 94, such as iris valve which is attached discharge device plate 93 may be fastened together using bolts, welds or with a V-band type clamp. Discharge device 94 may include valves, surge hoppers, filters, conveyors and the like.

I claim:

1. A bulk bag unloader comprising
an adjustable frame constructed without cross bracing,
a bottom frame secured to the adjustable frame,
a ram base removably secured to the bottom frame,
a bag tray adapted to support a bulk bag removably secured to the ram base,
a top frame secured to the adjustable frame,
an I-beam secured to the top frame, said I-beam being substantially the same length as the adjustable frame is wide,
a trolley adapted to traverse the I-beam, and
a hoist secured to the trolley.

2. The unloader of claim 1, further comprising a swiveled seat mounted to the adjustable frame.

3. A bulk bag unloader comprising
at least one horizontal frame support,
unloader frame brackets secured to the frame supports, and
a bag support hopper supported by the unloader brackets.

4. The unloader of claim 3, said hopper comprising hopper brackets adapted to support the hopper by the unloader frame brackets.

5. The unloader of claim 4, further comprising at least one spacer disposed the hopper brackets and unloader frame brackets.

6. The unloader of claim 4, further comprising at least one load cell disposed the hopper brackets and unloader frame brackets.

7. The unloader of claim 4, further comprising at least one vibration isolator disposed the hopper brackets and unloader frame brackets.

8. The unloader of claim 7, further comprising a vibration flange secured to the hopper.

9. The unloader of claim 3, further comprising a hopper flange ring secured to said hopper.

10. The unloader of claim 9, further comprising a discharge device plate secured to said hopper flange ring.

11. The unloader of claim 10, further comprising a discharge device removably secured to said discharge device plate.

12. The unloader of claim 11, wherein said discharge device is one taken from the group comprising a valve, surge hopper, filter, and conveyor.

13. The unloader of claim 3, further comprising a swiveled seat mounted to an unloader adjustable frame.

14. A bulk bag unloader comprising
at least one horizontal frame support,
unloader frame brackets secured to the frame supports,
a bag support hopper supported by the unloader brackets, and
a swiveled seat mounted to an unloader adjustable frame.
